(19) United States
(12) Patent Application Publication
(10) Pub. No.: US 2007/0181365 A1
(43) Pub. Date: Aug. 9, 2007

(54) ERGONOMIC GAME STAND

(76) Inventor: Troy Braud, Gonzales, LA (US)

Correspondence Address: NEIL J. COIG, 2355 DRUSILLA LANE, BATON ROUGE, LA, 70809, US

(21) Appl. No.: 11/307,411

(22) Filed: Feb. 6, 2006

(51) Int. Cl. E06C 7/16

(52) U.S. Cl. 182/115

(57) ABSTRACT

An improved game stand design providing an ergonomic seating position with seat and knee cushions which render both a more comfortable stand as well as a more versatile position, without sacrificing low weight and reduced bulk.

### BACKGROUND OF THE INVENTION

The present invention relates to an apparatus used for hunters to station themselves for tracking and harvesting wild game.

In the traditional mode of game stand technology, a stand is composed typically of a base and a platform for sitting upon, located within the stand. These stands vary in type, and include climbing stands, blind stands, lock-on stands, ladder stands and tripod stands, among others. Most stands utilize a seat of some type, but are often small and offer little on the order of comfort. This is largely a function of size, since the stands are typically small to ease in portability and to reduce the footprint of the stand, but also bearing on this factor are weight considerations, weather considerations, among others. Some stands, such as the Tree Lounge™, utilize a hammock-type seat, which is more comfortable, but consequently forego some maneuverability for the user while situated in the stand. Other stands afford more maneuverability at the cost of long term comfort. Essentially, no stand has been able to offer all features to the user.

Obvious downsides to the current type of game stand exist. If the seat is small, comfort is compromised. If the more comfortable hammock-type stands are used, it is more difficult to maneuver and to maintain balance while in the stand. The consequence of these issues is an uncomfortable hunt, or the risks associated with falling out of a stand while hunting. This is especially a concern when bow hunting, since the user must be able to situate himself in a completely upright position in order to draw his bow.

The present invention of an ergonomic game stand is thus a much-improved mode of producing a game stand, which addresses both comfort and maneuverability issues, while maintaining the standard requisites for a game stand, such as small footprint size and portability issues.

Other inventors have attempted to address the presented problem, such as the stand disclosed in U.S. Pat. No. 6,510,922 to Hodnett. However, this stand, while attempts have been made to increase comfort, the ergonomic issues remain. Clearly then, the present invention offers a much more complete and efficient solution that has yet to be addressed.

All of these aspects of the current state of the art lead to an increased need for an innovative stand design with improved ergonomics and implementation, all of which the present invention addresses.

### OBJECTS OF THE INVENTION

One object of the invention is to provide an improved game stand.

Another object of this invention is to provide a more ergonomically designed game stand.

Yet another object of this invention is to provide a more comfortable game stand.

Still another object of this invention is to provide a game stand which provides better maneuverability for the user.

Other objects and advantages of this invention shall become apparent from the ensuing descriptions of the invention.

### SUMMARY OF THE INVENTION

According to the present invention, an improved game stand design is disclosed, providing an ergonomic seating position with seat and knee cushions which render both a more comfortable stand as well as a more versatile position, without sacrificing low weight and reduced bulk.

### BRIEF DESCRIPTION OF THE DRAWINGS

The accompanying drawings illustrate an embodiment of this invention. However, it is to be understood that this embodiment is intended to be neither exhaustive, nor limiting of the invention. They are but examples of some of the forms in which the invention may be practiced.

FIG. 1 is a side view of the game stand with an angled seat cushion.

FIG. 2 is a top view of the game stand.

FIG. 3 is a perspective view of the game stand with the hunter in a seated position.

FIG. 4 is a perspective view of the game stand with the hunter in a kneeling position.

FIG. 5 is a perspective view of a “tripod” embodiment of the game stand having a bi-surface seat cushion.

FIG. 5A is an exploded view of the game stand pictured in FIG. 5.

FIG. 6 is a top view of the game stand pictured in FIG. 5 showing the pivotable seating area of the game stand.

FIG. 7 is a side view of a “lock-on” embodiment of the game stand.

FIG. 8 is a side view of a “ladder-type” embodiment of the game stand.

FIG. 9 is a tope view of a “lock-on” embodiment of the game stand.

FIG. 10 is a side view of a “lock-on” embodiment of the game stand showing how it may be collapsed for storage.

FIG. 11 is a rear view of the platform of the stand showing the seat cushion and first support structure.

FIG. 12 is a front view of the platform of the stand showing the knee cushion and second support structure.

FIGS. 13A-13E show various sample positions a user can take when using the stand.

### DETAILED DESCRIPTION OF EXEMPLARY EMBODIMENTS

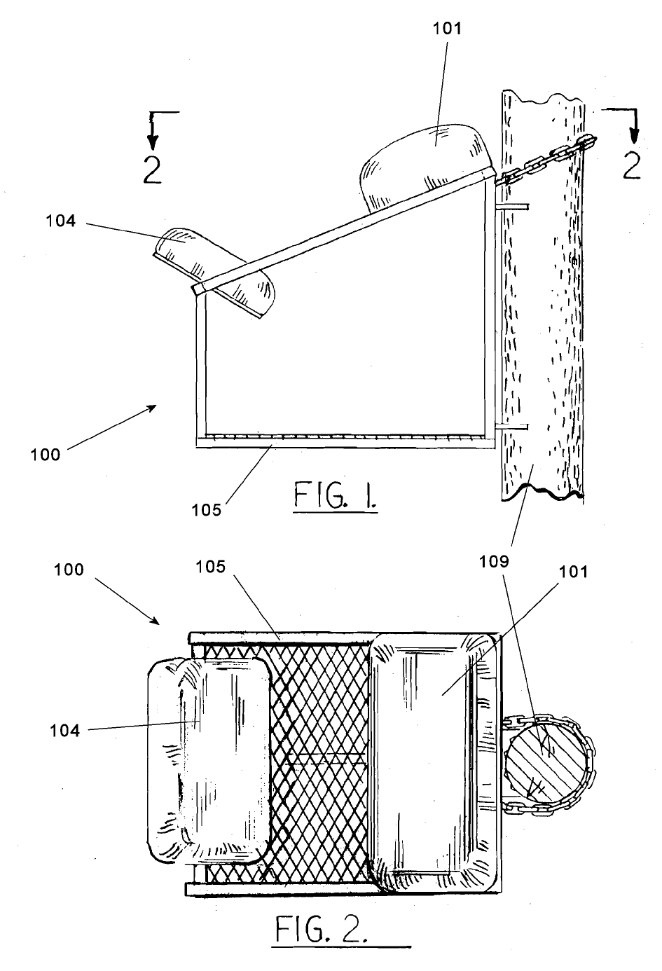

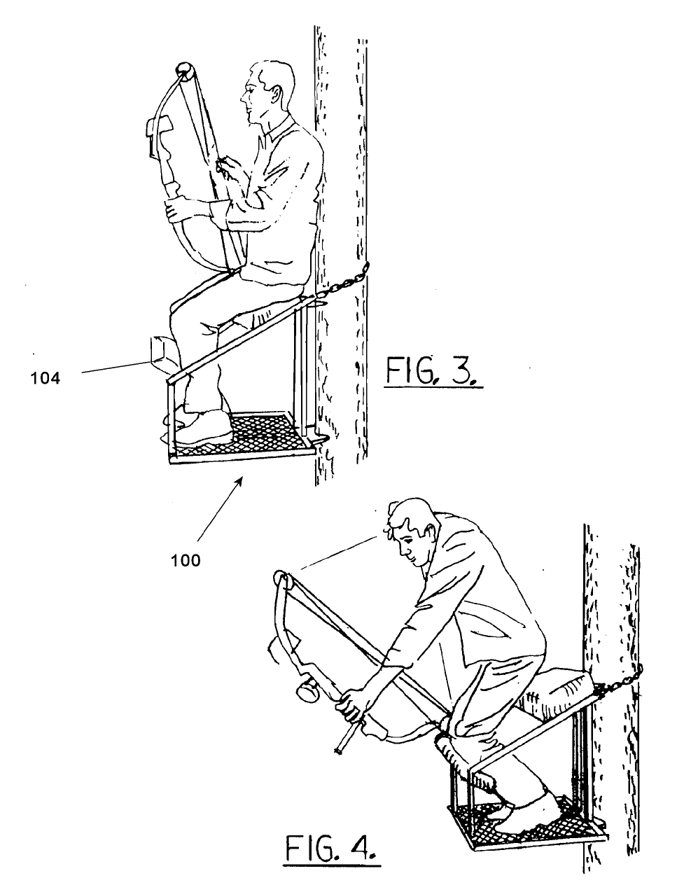

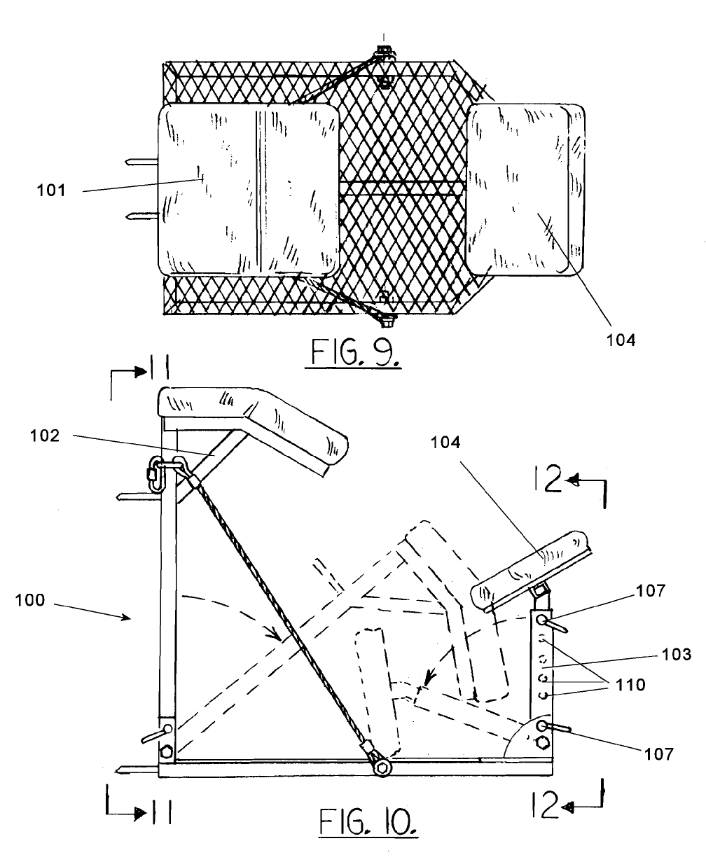

Without any intent to limit the scope of this invention, reference is made to the figures in describing the various embodiments of the invention. FIGS. 1-13 show various aspects of exemplary embodiments of the present invention.

The present invention relates to an ergonomically-designed game stand that can accommodate a hunter while pursuing game or participating in other outdoor activities, such as bird watching or photography. There are several types of game stands already in use, and the present invention seeks to improve upon those designs, as well as future designs of game stands. By implementing the disclosed seating position and design, nearly any, if not all, game stands could be improved from both an ergonomic and safety perspective. The seats offer more versatile positioning as well as ease in changing positions. Furthermore, the positions offered by the improved design help to promote circulation in a user's body, which increases comfort and reduces fatigue, in turn enabling longer, more satisfying hunts or observation outings.

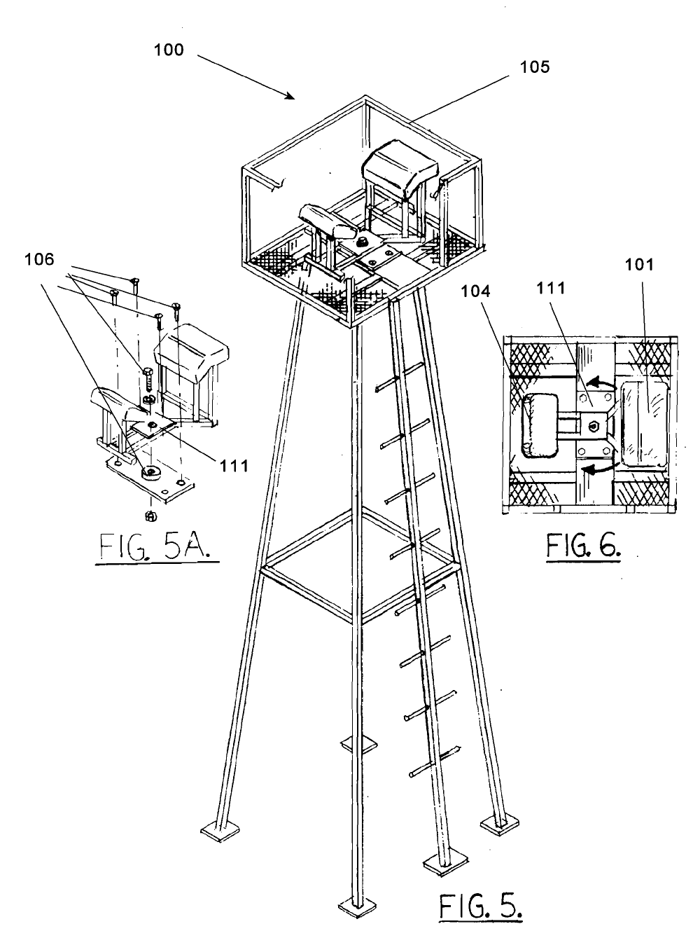

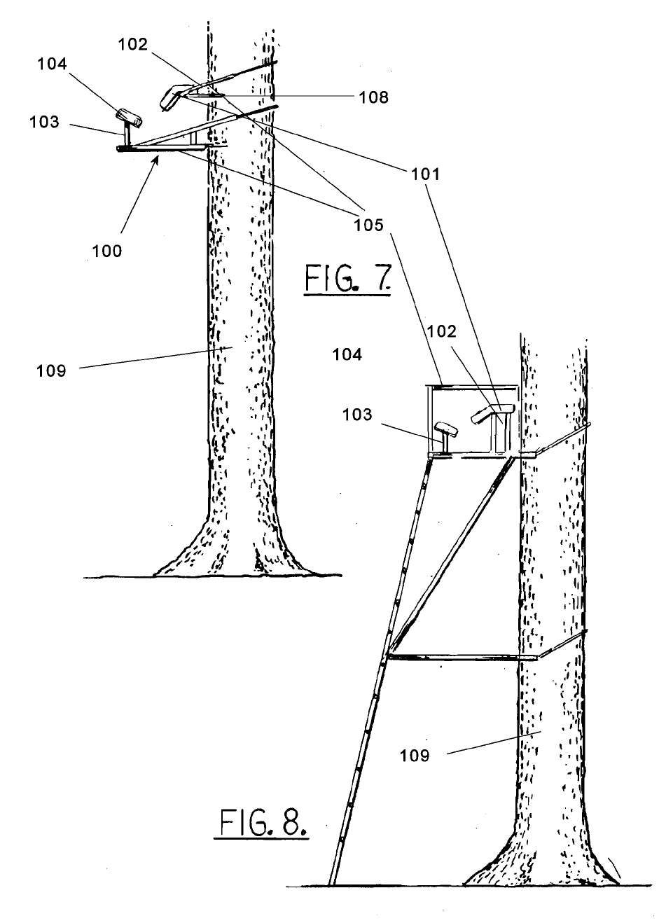

The improved design starts with a game stand, which can be any type of stand, blind or observation station, such as a “lock-on” type which attaches to the trunk of tree 109 or other vertical edifice at a desired height, pictured in FIG. 1; a “climbing” type which utilizes two pieces enabling a user to ratchet himself up tree 109 pictured in FIG. 7; a “ladder” type which consists of a stand that is leaned against tree 109 plus a ladder to access same, pictured in FIG. 8; a “tripod” type which is a free-standing raised stand, pictured in FIG. 5; as well as any other type of stand that is, or will be, implemented.

The seating position and equipment is then added to this basic stand design, wherein seat cushion 101 is attached to the top of first support structure 102 which is affixed to frame 105 of the stand. First support structure 102 can be of varying forms, such as simply being cross members attached across frame 105 as seen in FIG. 1, legs attached to the floor of a stand as in FIG. 8, or even the upper portion of frame 105 of a climbing stand as pictured in FIG. 7. Seat cushion 101 can be a multitude of designs, either a standard flat-type which sits parallel to the ground below, sloped at a forward angle, or a bi-surface design with both the flat as well as angled cushions integrated. In addition, a second support structure 103 is located in front of, and lower than, seat cushion 101, and has knee cushion 104 attached to the top thereof. In this way, knee cushion 104 is positioned lower and in front of seat cushion 101. Second support structure 103 can be attached to a stand in the similar and/or corresponding ways of first support structure 102.

In certain applications, such as the “tripod” stand pictured in FIG. 5, it may also be desired to enable the user to easily re-position in order to survey all 360 degrees of view around the stand. As such, a pivoting implementation of this arrangement may be incorporated as shown in FIG. 5A and 6. By interconnecting first support structure 102 and second support structure 103 into unitary support 111 and attaching it to frame 105 of game stand 100 via pivoting hardware 106 (such as a pin rotatable in a sleeve, a ball bearing with races or the like), the user of such a game stand would be able to pivot freely and survey the entire landscape, rather than being confined to facing in a single direction, or having to move the entire body to change viewing perspectives.

Adjustments to seat cushion 101 and knee cushion 104 can also be incorporated by providing an adjustment mechanism to re-position the cushions, an example of which can be seen in FIG. 10. As is seen in second support structure 103, knee cushion 104 is positionable by removing pin 107 from positioning hole 110 reconfiguring second support structure 103 and then replacing pin 107 in positioning hole 110 of desired configuration. Other adjustments can be incorporated as well, such as changing angles, heights, firmness, tilt, responsiveness and so forth, as desired by the application and/or user. Positioning can be achieved using the pin/hole configuration described above, or any other myriad modes of positioning, including friction stops, hydraulic cylinders or the like.

It should also be noted that this type of adjustment mechanism can be employed to make the stand more portable, as seen in FIG. 10, by enabling first support structure 102 and second support structure 103 to be collapsed and/or folded to reduce bulk.

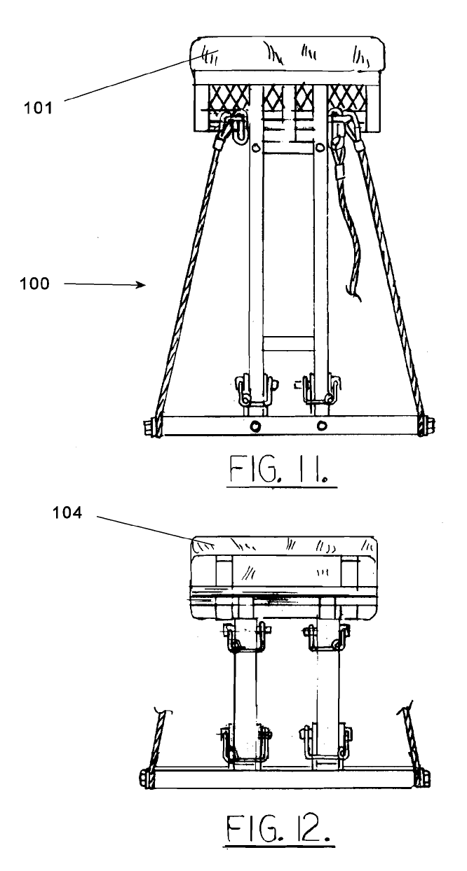

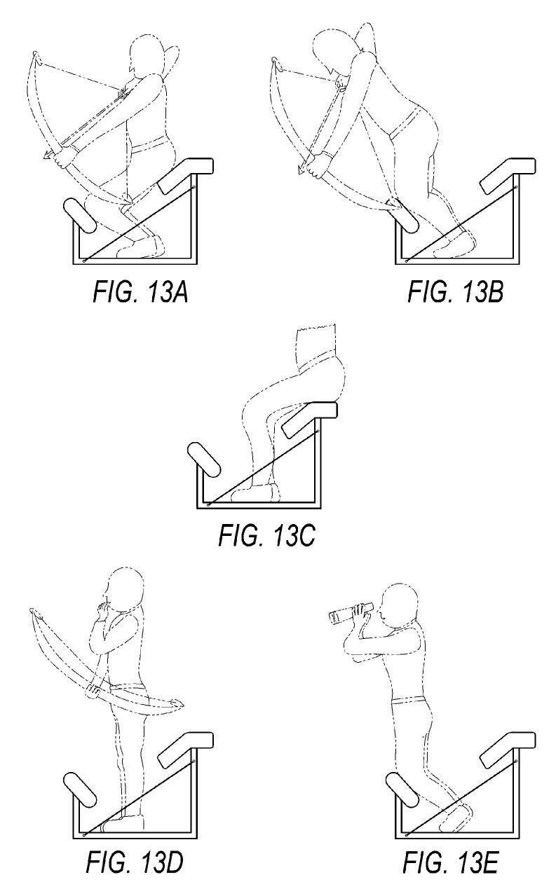

In operation, then, game stand 100 will be positioned where desired. As seen in the Figures, there are multiple positions that may be achieved, and easily changed between. First, there are the basic positions such as the standard sitting position, seen in FIG. 13C and the standing position, seen in FIG. 13D. However, the present invention also affords the basic kneeling position, shown in FIG. 13A in which a user sits partially on seat cushion 101 and partially on knee cushion 104. This distributes the weight and improves comfort both long- and short-term. The kneeling position can also be used, as shown in FIG. 13E, when in an upright position or even in a leaning position, such as that illustrated in FIG. 13B. Variants of these positions may also be used, and is should be noted that the transition from position to position is easy and requires a minimum of movement, a distinct advantage when hunting of watching wildlife, since a minimum of movement and noise is desired to prevent the spooking of game.

As seen above, using the disclosed configuration permits a user to utilize several varying positions in the stand, as well as to easily change between positions. For example, one position available is whereby the user enters a standard seating position with the feet are positioned flatly in game stand 100, whilst the user sits normally on seat cushion 101. It is very easy then to move from the seated position to another position that offers significant benefit, which is sitting with the knees also on knee cushion 104, so the user's weight can be more evenly distributed between the user's posterior and knees. From there, it is easy to move entirely to a kneeling positions on knee cushion 104 which achieves another benefit, since this kneeling configuration removes the weight from the user's posterior and allows for a great deal of articulation at the waist to gain the best position and angle and easily change position. This position affords a great advantage, especially for bow hunters, who require maximum articulation to draw their bow for a shot. As is seen, many positions as well as transitional positions between those above can be achieved using this stand design, and the benefits are many, including comfort, maneuverability, stealth and ease of use.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

What is claimed is:

1. A game stand comprising a supporting frame configured to accommodate at least one person, the improvement to which comprises:
a) first support structure operatively connected to said frame;
b) a seat cushion operatively attached to said first support structure;
c) second support structure operatively connected to said frame at a position fore of, and lower in height than, said first support means; and
c) a knee cushion operatively attached to said second support structure.

2. The game stand of claim 1 wherein said seat cushion is a bi-surface cushion wherein the first surface is substantially horizontal and the second surface is angled downward said knee cushion.

3. The game stand of claim 1 wherein said seat cushion is an angled cushion wherein the surface is angled downward said knee cushion.

4. The game stand of claim 1 further comprising a first adjustment mechanism which permits adjustment of said knee cushion by said user.

5. The game stand of claim 4 further comprising a second adjustment mechanism which permits adjustment of said seat cushion by said user.

6. The game stand of claim 1 further comprising a first adjustment mechanism which permits adjustment of said seat cushion by said user.

7. The game stand of claim 1 further comprising a rotatable platform upon which said first support structure and said second support structure are attached, permitting rotatable movement by a user.

8. The game stand of claim 1 wherein said game stand is configured as a lock-on stand.

9. The game stand of claim 1 wherein said game stand is configured as a climber stand.

10. The game stand of claim 1 wherein said game stand is configured as a tripod stand.

11. The game stand of claim 1 wherein said game stand is configured as a ladder stand.

12. The game stand of claim 1 wherein said game stand is configured as a blind.

13. The game stand of claim 1 wherein said game stand is configured to be collapsible.
